(19) United States
(12) Patent Application Publication
(10) Pub. No.: US 2019/0352196 A1
(43) Pub. Date: Nov. 21, 2019

(54) METHOD FOR ADSORPTION OF TOXIC CONTAMINANTS FROM WATER

(71) Applicant: QATAR FOUNDATION FOR EDUCATION, SCIENCE AND COMMUNITY DEVELOPMENT, DOHA (QA)

(72) Inventors: MUATAZ HUSSIEN, DOHA (QA); DEMA ALMASRI, DOHA (QA); TARIK RHADFI, DOHA (QA)

(73) Assignee: QATAR FOUNDATION FOR EDUCATION, SCIENCE AND COMMUNITY DEVELOPMENT, DOHA (QA)

(21) Appl. No.: 16/345,696

(22) PCT Filed: Oct. 27, 2017
(86) PCT No.: PCT/US2017/058720

§ 371 Date: Apr. 26, 2019

Related U.S. Application Data
(60) Provisional application No. 62/414,625, filed on Oct. 28, 2016.

(51) Int. Cl. C02F 1/28; B01J 20/02; B01J 20/12

(52) U.S. Cl. CPC C02F 1/281; C02F 2101/105; B01J 20/12; B01J 20/0229

(57) ABSTRACT

The present disclosure provides an iron-modified montmorillonite adsorbent for effectively removing heavy metals from water. The iron modified montmorillonite can be synthesized using a facile intercalation wet synthesis procedure that requires low energy and minimal use of chemicals. The iron modified montmorillonite adsorbent effectively removes heavy metals, such as arsenite, strontium, barium, phosphate, from water.

### TECHNICAL FIELD

The present disclosure relates to nanomaterials for the removal of toxic contaminants and, more particularly, to hydroxyiron modified montmorillonite clay for the removal of heavy metals.

### BACKGROUND ART

Heavy metal contamination of water is a matter of serious concern due its toxic effect on the environment. In particular, heavy metals accumulate in living organisms, causing long-term health complications in plants, animals, and humans.

Heavy metals are naturally occurring elements that have high atomic weight and high density compared to water. Water contaminated with heavy metals is typically treated by ion exchange, reverse osmosis, precipitation, filtration, and adsorption for removal of heavy metals. Adsorption is the most commonly used method due to its simple and economic effectiveness.

Arsenic contamination of water has received considerable attention due to its toxicity and health hazards. The detrimental effects of long-term exposure of arsenic in the environment are not uncommon and include: skin cancer, lung cancer, bladder cancer, kidney cancer, neurological disorders, muscle weakness, loss of appetite, and nausea. In 2006, due to its high toxicity, the United States Environmental Protection Agency (EPA) lowered the drinking water standard for arsenic from less than 0.05 mg/L to less than 0.01 mg/L. Arsenic mainly exists in natural waters as an inorganic species in two major forms, arsenite (As(III)) and arsenate (As(V)). Arsenite is more harmful to humans than arsenate and is more mobile in most environmental conditions. In groundwater, As(III) is more prevalent than As(V).

While arsenic contamination in natural waters is a worldwide concern, it is even more prevalent in wastewater due to the use of arsenic based pesticides, excessive mining, disposal of fly ash, and industrial activities. In this regard, several technologies have been developed and implemented for the removal of arsenic from wastewater. These technologies include oxidation/precipitation, coagulation/electro-coagulation or co-precipitation, ion-exchange, membrane filtration, and sorption techniques. The majority of the treatment methods are effective at reducing high initial arsenic concentrations (usually above 100 mg/L), but less effective at producing or further reducing significantly lower concentrations, typically leaving residual arsenic concentrations exceeding the water quality standard considered safe in most countries.

Adsorption is one of the leading techniques for the selective removal of arsenic and other heavy metals. Previous studies have shown that adsorption is an efficient technique, with various adsorbent materials, for the removal of contaminants from water. Activated carbon adsorbents are the most widely used for heavy metal, anion, and organic contaminant removal. Carbon nano-tubes are renowned for their excellent properties and applications. Use of carbon nano-tubes for removal of toxic metals and organic compounds has led to promising results. However, mass production is difficult, limiting availability.

Clay minerals have also been widely used as adsorbents due to their low-cost, natural abundance, and environmental friendliness. Activated carbon, the most utilized material for adsorption of contaminants, is expensive relative to clay minerals. The cost of clays ($0.04-0.12/kg) are, in some cases, hundreds of times cheaper than activated carbon ($20-$22.00/kg). In addition, clays typically exhibit moderately large specific surface areas and high cation exchange capacities (CECs).

Montmorillonite (MMT) is a member of the larger smectite clay group, having a formula of (Na,Ca)_{0.33}(Al,Mg)₂(Si₄O₁₀)(OH)₂ XH₂O. As shown in FIG. 1, MMT is distinguished by its structure which comprises a 2:1 sheet with one Al³⁺ octahedral sheet sandwiched between two Si⁴⁺ tetrahedral sheets. Due to isomorphic substitution in the interlayer sheets and on broken edge sites of silica-alumina units, MMT has a high net negative charge, allowing for a high cation exchange capacity and layer expansion capacity. This property makes it superior to other clay counterparts (i.e., kaolinite and illite). Due to its advantageous properties, MMT clay has been extensively used and studied for numerous applications, including as a catalyst in organic synthesis; as an antibacterial agent; in drug delivery; in food packaging; and as a sorbent material for water treatment.

MMT, in its principal form, is an effective adsorbent with respect to several contaminants; its ease of modification for the synthesis of several adsorbents makes it a highly attractive adsorbent. While many studies exist on the removal of As(V) from water using MMT, few have covered removal of the As(III) species. Furthermore, previous studies only discuss the development of pillared clays for the removal of arsenic or heavy metals from water. The pillaring synthesis process requires very high temperatures, making it costly for industrial applications. To reduce cost and improve adsorption of heavy metals from water, more affordable and efficient clay compositions and methods of preparing them are needed.

### DISCLOSURE OF INVENTION

The present disclosure provides a method for removal of toxic contaminants from water including contacting the water with a modified montmorillonite. The modified montmorillonite includes a plurality of montmorillonite layers and a metal hydroxide modifier. The metal hydroxide modifier is intercalated in the montmorillonite layers and on a surface of an outer layer. The modified montmorillonite includes at least about 80 wt % montmorillonite and about 1 wt % to about 20 wt % metal hydroxide modifier. The metal hydroxide modifier includes at least one of iron, manganese, aluminum, cobalt, and copper.

The modified montmorillonite can be synthesized using a facile intercalation wet synthesis procedure that requires low energy and minimal use of chemicals. The modified montmorillonite clay can be used to effectively remove heavy metals, such as, arsenite, and other contaminants such as strontium, barium, and phosphate, from water. The modified montmorillonite clay can be used in conjunction with a packed bed to effectively remove the heavy metals.

A method of synthesizing the modified montmorillonite may include: preparing an aqueous montmorillonite clay solution; adding a metal hydroxide solution to the aqueous montmorillonite clay solution to form a first reaction solution; adding ammonium hydroxide to the first reaction solution to form a second reaction solution; heating the second reaction solution under constant stirring to form a modified montmorillonite clay solution; washing the modified montmorillonite clay solution; and drying the washed montmorillonite clay solution, to obtain the modified montmorillonite.

A method of synthesizing hydroxyiron modified montmorillonite may include: preparing an aqueous montmorillonite clay solution; adding an iron (III) hexahydrate (FeCl₃.6H₂O) solution to the aqueous montmorillonite clay solution to form a first reaction solution; adding a diluted ammonium hydroxide solution to the first reaction solution to form a second reaction solution; heating the second reaction solution under constant stirring to form an hydroxyiron modified montmorillonite clay solution; and separating the hydroxyiron modified montmorillonite from the hydroxyiron modified montmorillonite clay solution. The hydroxyiron modified montmorillonite clay effectively removes arsenite from water.

These and other features of the present subject matter will become readily apparent upon further review of the following specification and drawings.

### BRIEF DESCRIPTION OF DRAWINGS

The drawings and detailed description which follow are intended to be merely illustrative of the exemplary embodiments and are not intended to limit the scope of the invention as set forth in the claims.

FIG. 1 illustrates the structure of MMT clay.

FIG. 2 shows a schematic diagram of a reaction scheme for the preparation of HyFe-MMT.

FIG. 3 shows the X-Ray Diffraction (XRD) pattern of MMT and 10% HyFe-MMT, respectively.

FIG. 4A and FIG. 4B show Thermogravimetric Analysis (TGA) and Derivative Thermogravimetric Analysis (DTG) curves of MMT and HyFe-MMT, respectively.

FIG. 5 shows the FT-IR spectra of MMT, 10% HyFe-MMT, and modified MMT after As (III) adsorption at pH, respectively.

FIG. 6A and FIG. 6B show Scanning Electron Microscopy (SEM) images of MMT.

FIG. 6C and FIG. 6D show Scanning Electron Microscopy (SEM) images of 10% HyFe-MMT.

FIG. 7 is a graph showing the effect of an adsorbent dosage of MMT, 1% HyFe-MMT, 5% HyFe-MMT, 10% HyFe-MMT, and 20% HyFe-MMT on the removal of As(III).

FIG. 8 is a graph showing the effect of contact time of MMT and 10% HyFe-MMT on the percent removal of As(III).

FIG. 9 is a graph showing the kinetics for MMT and HyFe-MMT adsorption of As (III).

FIG. 10 is a graph showing the effect of pH on As(III) adsorption.

FIG. 11 is a graph showing Arsenic (III) equilibrium adsorption isotherms for MMT and 10% HyFe-MMT at 25° C. and pH 6.

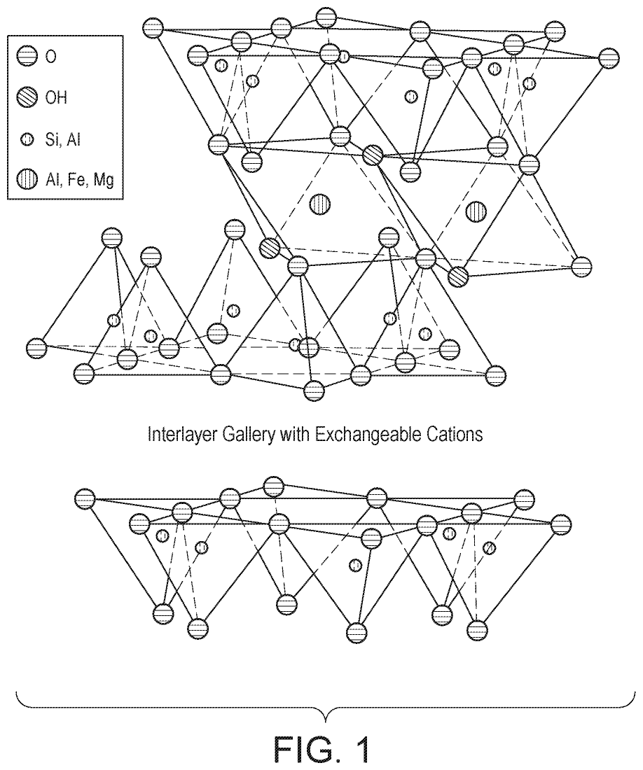

### BEST MODES FOR CARRYING OUT THE INVENTION

Reference will now be made to exemplary embodiments of the present subject matter, examples of which are illustrated in the accompanying drawings. For purposes of this disclosure, the term “montmorillonite” is used interchangeably with “MMT”. Similarly, the term “hydroxyiron modified montmorillonite” is used interchangeably with “HyFe-MMT”.

A method for removal of toxic contaminants from water includes contacting the water with a modified montmorillonite. The modified montmorillonite can be prepared by a simple intercalation procedure whereby precursors are added to montmorillonite in an aqueous medium under mild conditions. The modified montmorillonite presents extremely high adsorption of arsenite. The modified montmorillonite can also remove other contaminants, such as strontium, barium, and phosphate, with high adsorption efficiency.

The modified montmorillonite can include hydroxyiron modified montmorillonite. HyFe-MMT can be prepared using a facile intercalation procedure whereby precursors are added to montmorillonite in an aqueous medium under mild conditions. The procedure can be a simple wet chemical synthesis method. The hydroxyiron modified montmorillonite can include about 1% to about 20% iron, and preferably about 10% iron. The hydroxyiron modified montmorillonite removes inorganic pollutants from water and can be applied in tandem with a wide variety of treatment systems such as packed bed filters. In addition, this material can be used for various water types to remove numerous contaminants. For example, the prepared hydroxyiron modified montmorillonite showed more than 90%, 95%, 95%, and 82% removal of arsenic, barium, strontium, and phosphate, respectively. In particular, the hydroxyiron modified montmorillonite removed 90% of arsenic at about neutral pH (pH 6-7). The hydroxyiron modified montmorillonite also exhibited excellent adsorption kinetics, i.e., 55% removal of arsenic within 30 seconds of the adsorption process.

Both the modified and unmodified montmorillonite were characterized using a series of characterization tools and their effectiveness was tested for the removal of As(III) in a synthetic As(III) aqueous solution. The removal of arsenite (As (III)) by raw MMT and HyFe-MMT was compared and evaluated by adsorption experiments conducted under various conditions (adsorbent dosage, iron loading, contact time, pH, and initial As(III) concentration). For example, HyFe-MMT exhibited fast adsorption kinetics, including more than 55% As(III) removal within the first 30 seconds of the reaction. The kinetics were most accurately modeled using the pseudo-second-order equation (R²=1). In some embodiments, optimum As(III) adsorption was obtained at a pH level ranging from about pH of 6 to about pH 7. The Freundlich model properly described the adsorption process (R²>0.99). The HyFe-MMT can effectively adsorb arsenic from contaminated water, e.g., groundwater, drinking water, or wastewater.

The HyFe-MMT's adsorption capacity was not highly affected within the pH range of 6 to 9 at high iron concentrations, but was very dependent on the iron loading. The Freundlich isotherm parameter (1/n) also indicated that significant As(III) adsorption can be expected even at higher As(III) concentrations. Overall, the HyFe-MMT material presented a promising adsorbent for As(III) removal from contaminated water such as groundwater, drinking water, or wastewater.

The following examples are given by way of illustration, and should not be construed to limit the scope of the present invention.

### Example 1

### Synthesizing HyFe(III)-MMT

All solutions were prepared from analytical reagent grade chemicals and deionized water (Milli-Q system). Iron (III) chloride hexahydrate (FeCl₃.6H₂O) and ammonia were obtained from SureChem (Suffolk, England) and VWR Chemicals, respectively. K-10 montmorillonite (MMT) supplied by Sigma-Aldrich Company Ltd. was used as the starting material without any modifications. The cation exchange capacity of the material was found to be 30 meq/100 g. A stock solution of arsenite (1000 mg/L) was purchased from VWR Chemicals.

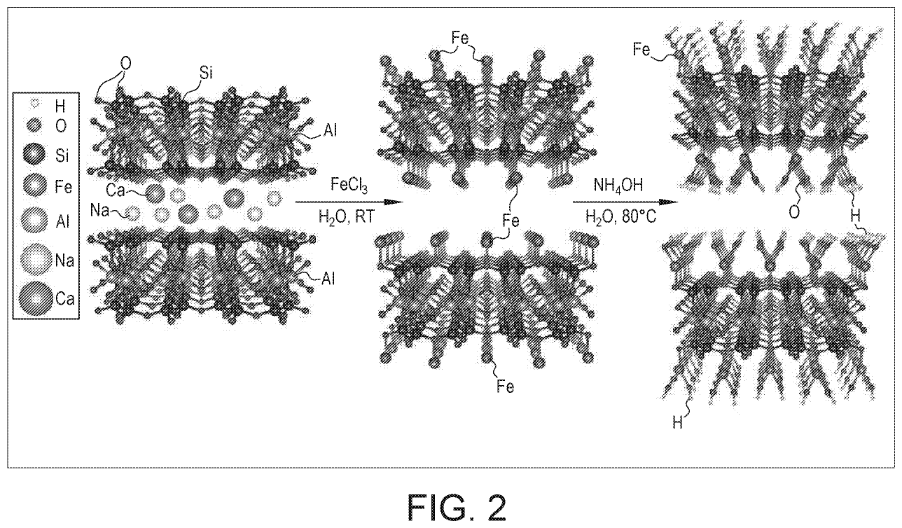

FIG. 2 shows a schematic diagram of the reaction scheme for the preparation of HyFe-MMT according to the instant example. Briefly, 2 g of MMT clay was dispersed in water in a three neck flasks and mechanically stirred at 300 rpm for 15 minutes. Then, the desired concentration of FeCl₃.6H₂O (1 weight % to 20 weight %) solution was added drop-wise to the MMT clay solution, and the suspension was stirred for another 15 minutes. A diluted ammonium solution was prepared such that the number of moles of hydroxide from NH₄OH was three times the number of moles of iron. The resultant suspension was mechanically stirred for 30 minutes at room temperature, and then for two hours at a temperature of 80° C. for the iron (III) hydroxide modification reaction to take place, as shown in FIG. 2. Afterwards, the HyFe-MMT material was separated from the mixture, washed, and centrifuged five times with Milli-Q water. The wet HyFe-MMT was then dried in a freeze drier at −80° C. under vacuum overnight, followed by drying in a furnace at 80° C.

### Example 2

### Characterization of HyFe-MMT

Powder XRD measurements were carried out using a Rigaku Miniflex-600 X-ray diffractometer with Cu Kα radiation (X=0.154 nm). XRD data in the 20 range from 5 to 70° were obtained. The chemical groups in the materials developed were obtained from FTIR data using a FTIR spectrometer (Thermo Fisher Scientific Nicolet iS 10) in the wavenumber range of 4000-500 cm⁻¹. X-ray Fluorescence (XRF) data was collected on a Rigaku ZSX Primus II Wavelength Dispersive XRF to determine the quantitative elemental analysis of the material. The specific surface area of the unmodified and hydroxyiron modified MMT was measured at 77K using N₂ as an adsorbate on a Micromeritics ASAP 2020 BET surface area analyzer. TGA of the material was performed using a TGA system (TA instruments SDT Q600) at a heating rate of 10° C./min. The surface morphology of the samples was carried out using an FEI Quanta 400 environmental scanning electron microscope (ESEM) at 30 kV.

Transmission electron microscope (TEM) images were obtained by placing the sample on lacey carbon film using FEI Talos F200X TEM microscope operating at 200 kV and equipped with a scanning transmission electron microscope (STEM) and an energy dispersive X-ray spectroscope (EDX).

### Example 3

### Arsenic Adsorption Experiments

Arsenic adsorption experiments were conducted to determine the adsorption capacity of As(III) on MMT and HyFe-MMT. These experiments were carried out in 50 mL centrifuge tubes containing 20 mL of an As(III) solution to a predetermined amount of MMT or HyFe-MMT. The pH of the solution was adjusted with 0.1 mol/L HCl or 0.1 mol/L NaOH. All of the solutions were mechanically agitated on a shaker at 350 rpm. For the adsorption kinetics and adsorbent dosage experiments, the pH of the initial As(III) solution was not altered, so as to depict a system with no external influence, and was found to be at a pH of 3. All experiments were conducted at room temperature. Kinetics experiments were conducted at time intervals ranging between 0.5 min to 120 min to determine the equilibrium contact time and maximum adsorption capacity.

The most efficient adsorbent dosage was determined from experiments using different adsorbent amounts ranging from 20 mg to 100 mg. Experiments investigating the effect of pH on adsorption capacity were conducted at pH ranging from 3 to 9. Initial As(III) concentration experiments were carried out after the pH experiments at As(III) initial concentrations ranging from 0.25 mg/L to 10 mg/L, at a pH of 6.

The adsorption capacity, qₜ, at a specific time t and the percent removal of arsenite were calculated based on the following equations:

$$\begin{matrix}{q}_{t} = \frac{( {C}_{0} - {C}_{t} ) V}{W} & ( 1 ) \\ percent removal ( \% ) = \frac{( {C}_{0} - {C}_{t} )}{{C}_{0}} \times 100 \% & ( 2 )\end{matrix}$$

where C₀ (mg/L), and C₁ (mg/L) are respectively the initial and equilibrium As(III) concentrations, V (L) is the volume of the solution, and W (g) is the weight of the adsorbents MMT or HyFe-MMT. All experimental data were averages of duplicates.

The major elements of MMT and HyFe-MMT were determined by XRF chemical analysis (weight %) and are expressed as oxides of the samples in Table 1. The weight % of Fe₂O₃ was found to increase with the addition of Fe³⁺ polycationic species. The amount of iron loaded on MMT (in the form of Fe₂O₃) for 1%, 5%, 10%, 20% HyFe-MMT can be derived from the table to be 2.04, 6.14, 9.3, and 13.6 weight %, respectively. Trace elements were detected but were excluded from the discussion due to their low relevance relative to the other oxides, which explains the total not adding up to 100%.

TABLE 1
XRF elemental analysis of MMT and Fe-MMT

| Sample | Na₂O | MgO | Al₂O₃ | SiO₂ | K₂O | CaO | TiO₂ | Fe₂O₃ | Total |
|---|---|---|---|---|---|---|---|---|---|
| MMT | 0.152 | 1.3 | 14.4 | 76.2 | 1.72 | 0.196 | 0.679 | 3.5 | 98.15 |
| 1% Fe-MMT | 0.187 | 1.31 | 15.4 | 74.2 | 1.83 | 0.175 | 0.666 | 5.54 | 99.31 |
| 5% Fe-MMT | 0.147 | 1.16 | 13.7 | 71.4 | 1.64 | 0.0581 | 0.588 | 9.64 | 98.33 |
| 10% Fe-MMT | 0.162 | 1.08 | 13 | 66 | 1.66 | 0.0416 | 0.588 | 12.8 | 95.33 |
| 20% Fe-MMT | 0.151 | 1.02 | 12.6 | 64.8 | 1.63 | 0.0405 | 0.567 | 17.1 | 97.91 |

Interestingly, from Table 1, a noticeable decrease in Ca content was observed for the hydroxyiron modified MMT. In fact, the reduction in Ca content reaches approximately 80% for 20% HyFe-MMT. This could indicate that the method of intercalation is via the exchange of the interlayer Ca²⁺ ions for the polycationic species of iron and confirms the entrance of the polycationic species in between the MMT layers. The very small change in sodium content may attribute to the lack of sodium exchange occurring during the intercalation procedure. This phenomena is most likely attributed to the successful exchange of polycationic species with Ca²⁺ ions.

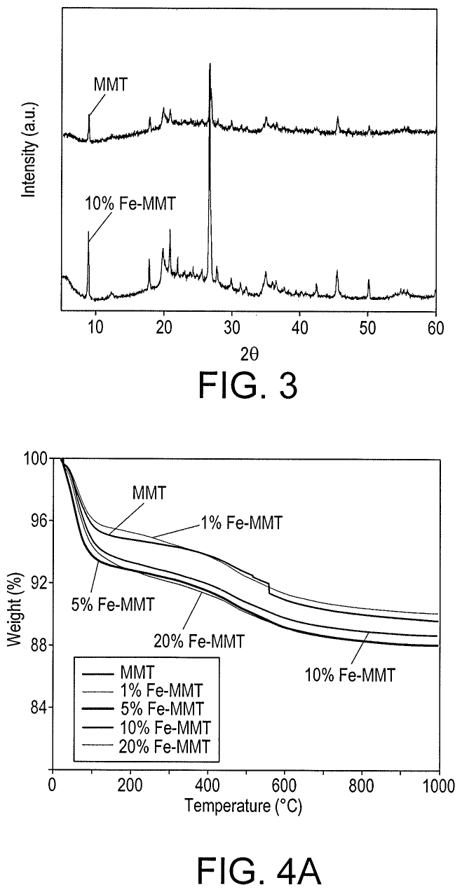

The powder XRD of MMT and hydroxyiron MMT at different loadings are depicted in FIG. 3. The overall XRD patterns for the modified MMT samples are very similar to unmodified MMT and show that the ordered structure of MMT was retained after intercalation with iron. The inset XRD image in FIG. 3 depicts a close up of the (001) reflections for all the samples; the d-spacing and 20 values are summarized in Table 2. The interlayer-spacing of the (001) reflection was calculated by the following Bragg equation:

$$d = \frac{λ}{2 sin θ} \qquad ( 3 )$$

TABLE 2
XRD and surface area parameters of MMT and HyFe-MMT

| | | | BET specific surface |
|---|---|---|---|
| Type | 2θ | d (nm) | area (m²/g) |
| MMT | 8.90 | 0.992 | 265 |
| 1% HyFe-MMT | 8.88 | 0.995 | 277 |
| 5% HyFe-MMT | 8.89 | 0.994 | 282 |
| 10% HyFe-MMT | 8.90 | 0.993 | 337 |
| 20% HyFe-MMT | 8.89 | 0.994 | 355 |

The basal spacing for unmodified MMT was found to be d(001)=0.992 nm (2θ=8.90°), which is typical for K10 montmorillonite. The d-spacing increased (see the insert in FIG. 3 and Table 2) to 0.995 nm for 1% HyFe-MMT indicating that Fe(III) intercalated in between the layers, but a gradual decrease was observed for 5% HyFe-MMT and 10% HyFe-MMT. After 10% HyFe-MMT, the basal spacing increased again to 0.994 for 20% HyFe-MMT. Modifications in the basal spacing largely rely on the charge, size, and the hydration behavior of the element within the interlayer, in addition to interactions and the phyllosilicate layers. Initially, for 1% HyFe-MMT, the d-spacing could have increased due to hydroxyiron (III) intercalating and insufficient amounts intercalating to push out calcium ions. For 5% HyFe-MMT and 10% HyFe-MMT, the higher hydroxyiron (III) content may have replaced more calcium ions and the relatively smaller size of iron can in principle justify the decrease in basal spacing. The increase in basal spacing for 20% HyFe-MMT could be due to an excess of hydroxyiron (III) available in the interlayer making up for the loss of calcium ions.

The impact of Fe(III) species on the d-spacing of montmorillonite is diverse. A slight decrease in the basal spacing of MMT after modification with Fe(III) can be attributed to the smaller radii of Fe³⁺ and [Fe(OH₂)₆]³⁺ species relative to those of Na⁺ and [Na(OH₂)₆]⁺ species. A decrease in d₀₀₁ after modifying MMT with Fe(III) can also be attributed to the strong attractive forces between Fe(III) and the silicate sheets of MMT. On the other hand, an increase in d-spacing can be attributed to the replacement of native ions with relatively larger and more hydrated iron species. Since a significant change in the d-spacing of the unmodified MMT and modified MMT was not witnessed, most of the Fe(III) species may exist on the surface of the clay sheets. No strong evidence for the existence of a separate Fe(III) (hydr)oxide phase was shown in XRD. No well-defined diffraction peak indicating the presence of iron oxocation formation was observed. This was probably attributed to the difference in size in oxocations and their interaction with the clay layers such as aggregation or adsorption on the surface of clay flakes. As specified in previous literature, besides being positioned in between clay's layers in different forms, iron species can be located on the surface of clay flakes.

The surface areas analyzed by BET N2 for MMT and HyFe-MMT are depicted in Table 2. An increase in surface area can be observed with the increase in hydroxyiron (III) modification of MMT. This increase in surface area by hydroxyiron (III) intercalation provides an indication of the increase in sites for adsorption.

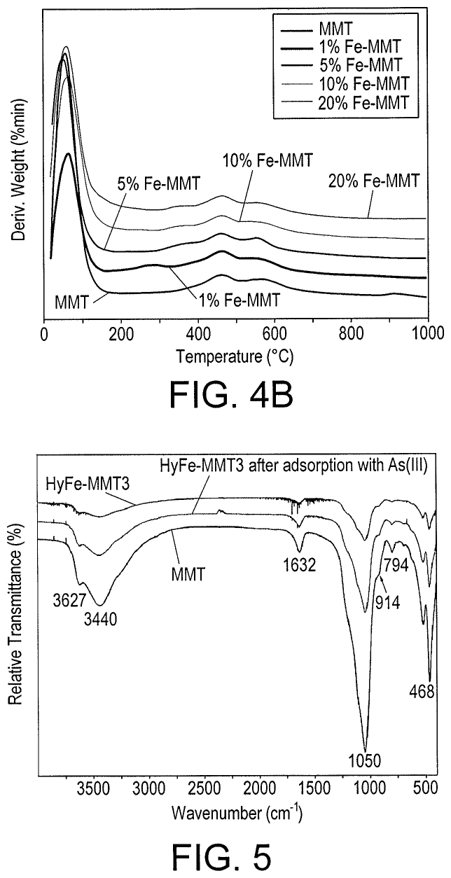

FIGS. 4(A) and 4(B) show the TGA and DTG curves of MMT and HyFe-MMT (1% HyFe-MMT, 5% HyFe-MMT, 10% HyFe-MMT, and 20% HyFe-MMT). There were two main losses observed for all samples. The first significant loss showed a weight loss of 7% at temperatures up to 100° C. which is attributed to the release of water within the interlayer cations and water adsorbed on the particle surface. The second, less intense weight loss of approximately 2%, observed between 450° C. and 600° C., could be attributed to the dehydroxylation of structural aluminosilicate OH groups. No other major weight losses were observed, indicating a fairly stable material at this temperature range.

The FT-IR spectra of MMT, 10% HyFe-MMT, and the modified MMT after As (III) adsorption at pH 6 are depicted in FIG. 5. The peak at 3627 cm⁻¹ depicts the stretching vibration of Al—OH structural groups of montmorillonite. The broad peak at 3440 cm⁻¹ denotes the vibrational stretching of OH groups of adsorbed water. The band intensity of the modified MMT decreased which can be attributed to the replacement of hydrated inorganic cations of the initial nanoclay with polymeric iron cations during the exchange process. The peak at 1632 cm⁻¹ corresponds to the deformation of OH groups of water. The presence of the strong peak at 1050 cm⁻¹ indicates Si—O stretching vibrations of the tetrahedral sheet, revealing that no change occurred on the peak after modification of MMT. The peaks at 912 cm-1 and 794 cm⁻¹ could also indicate Si—O stretching vibrations. The peak at 794 cm⁻¹ of 10% HyFe-MMT after As(III) adsorption can be assigned to the stretching vibration of the As—O bond, as indicated by previous research, and overlaps with the Si—O band. This peak is more intense after arsenite adsorption relative to the hydroxyiron modified MMT which can indicate As(III) adsorption on the hydroxyiron. The vibration modes specific to those of iron species could not be clearly resolved in the FTIR spectra as the bands belonging to the stretching of Fe—O at 468 cm¬−1 and Fe—O—H at 1000 cm⁻¹ interfered with those of the MMT counterpart in 10% HyFe-MMT before and after adsorption.

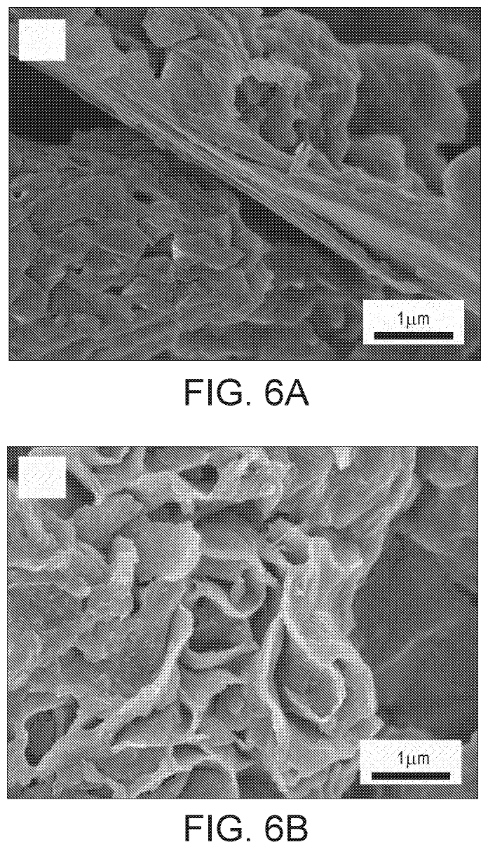

FIGS. 6A-6D show field emission gun scanning electron micrographs (FEG-SEM) of MMT and 10% HyFe-MMT. The 10% HyFe-MMT sample was chosen for SEM characterization since it was used for the equilibrium experiments. FEG-SEM observations for raw MMT indicate that it is a lamellar material consisting of several arrays of cleaved sheets. The morphology of the modified MMT was quite similar to that of raw MMT. The images show that both MMT and 10% HyFe-MMT had irregular surfaces with obvious undulations, signifying a crystalline-type order and stacked sheets.

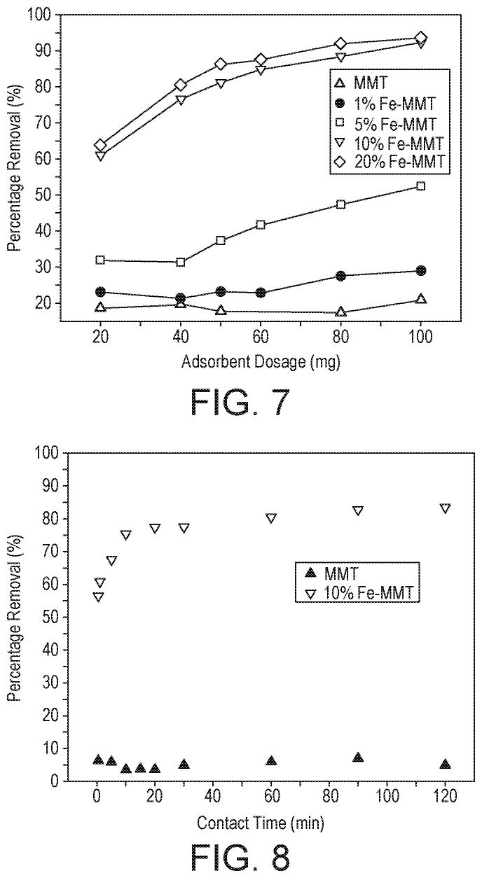

FIG. 7 shows the effect of the adsorbent dose on the removal of As(III) for MMT and HyFe-MMT at different Fe (III) loadings. As observed from FIG. 7, 80 mg of the modified MMT dosage is sufficient for quantitative adsorption of As(III). The amount of As(III) removed increases with increasing dosage of the modified MMT, and/or with increasing amount of Fe in the modified MMT. However, no significant change of the percent removal was observed for unmodified MMT as a function of dosage.

Since adsorption on MMT is much less significant than HyFe-MMT, it is clear that adsorption onto HyFe-MMT is due to the Fe(III) species which provide complimentary adsorption sites for As(III) species. A difference in As(III) adsorption is not noteworthy for the 10% HyFe-MMT and 20% HyFe-MMT, indicating that the iron(III) amount in 20% HyFe-MMT was in excess and exchangeable sites were no longer available. The 10% HyFe-MMT at an adsorbent dosage of 80 mg was found to provide the most efficient adsorption of As(III), and, thus, further experiments were conducted at these parameters.

FIG. 8 shows the effect of contact time of MMT and 10% HyFe-MMT on the percent removal of As(III). In particular, experiments were conducted at various times to determine the effect of contact time on the uptake of As(III) and to establish the time it takes for the reaction to reach equilibrium. All other parameters were kept constant, and the pH of the reaction was left as is at a pH of 3 without further adjustment. A small amount of As(III) removal was observed using MMT, and an increase in As(III) percent removal was nearly negligible with time. On the other hand, it can be observed that, using HyFe-MMT, As(III) removal increases with increasing contact time and more than 55% of As(III) is removed within the first 30 seconds of the reaction. Most of the adsorption can be seen to take place rapidly during the initial 15 minutes of the reaction, while the rest of the adsorption takes place at a slower rate.

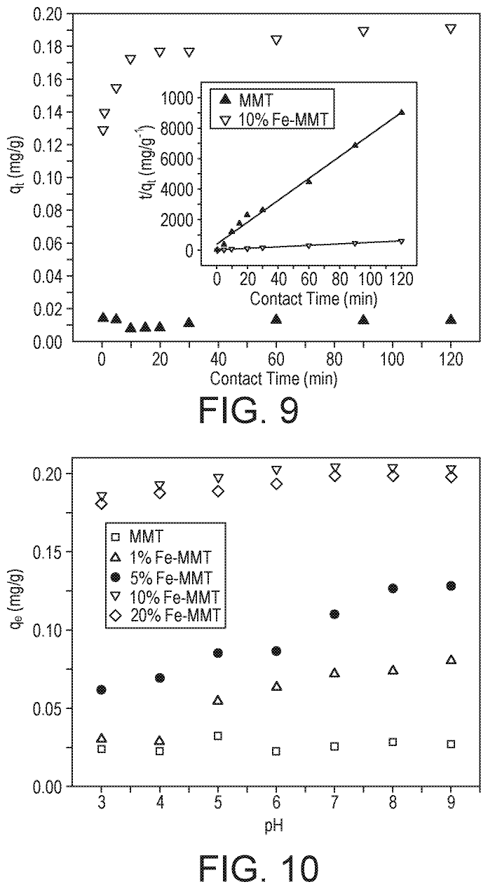

FIG. 9 shows the adsorption kinetics for As(III) for MMT and 10% HyFe-MMT. The adsorption capacity increased from 0.0113 mg/g for MMT to 0.191 mg/g for 10% HyFe-MMT. A significantly rapid reaction was observed for the HyFe-MMT within the first 30 seconds, and the adsorption equilibrium was reached within 2 hours. Less than 4% increase in adsorption capacity was observed between 30 minutes to 2 hours of contact time. The rapid adsorption in the initial stage can be attributed to the more available sites for adsorption due to Fe(III) modification and due to a greater concentration gradient. Following the results obtained from the kinetics experiments, an equilibrium time of 2 hours was chosen for all of the experiments.

In order to study the kinetic mechanism that defines the adsorption process, pseudo-first-order, pseudo-second-order, and intraparticle diffusion models were developed to analyze the experimental data. Due to the poor regression coefficient (R²) values for the first-order and intraparticle diffusion models, the outcomes were not incorporated in this work.

The pseudo-second-order model is represented as follows:

$$\begin{matrix}\frac{{dq}_{t}}{dt} = {{k}_{2} ( {q}_{e} - {q}_{t} )}^{2} & ( 4 ) \\ \frac{t}{{q}_{t}} = \frac{1}{{k}_{2} {q}_{t}^{2}} + \frac{t}{{q}_{e}} & ( 5 )\end{matrix}$$

where qₜ (mg/g) is the amount of As (III) adsorbed at a certain time t (min), qₑ (mg/g) is the amount of As(III) adsorbed at equilibrium, and k₂ (g/mg-min) is the pseudo-second-order reaction rate. From the intercept and slope of the (t/qₜ) vs. t plot, k₂ and qₑ can be determined, respectively.

The inset of FIG. 9 shows the pseudo-second-order model fit in which the HyFe(III) modified MMT was observed to fit well over the entire adsorption period as implied by the very high correlation coefficient. The calculated equilibrium capacity obtained from the inset of FIG. 8 was similar to that obtained from experimental analysis (Table 3).

TABLE 3
Pseudo-second-order isotherm parameters

| | qₑ (experimental) | qₑ (calculated) | | |
|---|---|---|---|---|
| Sample type | (mg/g) | (mg/g) | k₂ (g/mg-min) | R² |
| MMT | 0.0113 | 0.0135 | 14.2 | 0.991 |
| 10% | 0.191 | 0.191 | 4.51 | 1.00 |
| Fe-MMT | | | | |

FIG. 10 shows As(III) adsorption plots at various pH values. In general, it can be observed that As(III) adsorption increased with increasing pH, up to a pH of 9. The trend in adsorption capacity of unmodified MMT in the given pH range is significantly lower than modified MMT. This could imply that the SiO₄ tetrahedral, the major surface component of MMT, is less reactive than the available Fe—OH group on MMT. When MMT is modified with 1% and 5% iron, the total Fe₂O₃ content is 5.54 weight % and 9.64 weight %, respectively, from XRF data. The neutral H₃AsO₃ is the dominant arsenite species at a pH environment less than 9.2 (H₃AsO₃, pKa=9.2). As(III) acts as a weak acid under this condition in which the adsorption capacity is expected to reach its maximum at the pKa of the acid. The increase in As(III) adsorption in a high alkaline environment for 1% and 5% HyFe-MMT could imply that electrostatic forces are not controlling factors in the adsorption process and the adsorption process may follow surface complexation and ligand exchange between the hydroxide on the MMT surface and arsenite species rather than electrostatic interaction.

At a higher iron content (10% HyFe-MMT and 20% HyFe-MMT), general adsorption behavior of the modified sorbent, i.e. pH dependency, is comparable to the behavior of amorphous iron oxide (FeOOH) and ferrihydrite. A significant change in adsorption capacity for As(III) was not observed between the pH range of 4-9. At pH<9, attraction and repulsion is not effective towards neutral H₃AsO₄ since the adsorption process may be controlled by deprotonation/dissociation of H₃AsO₃ by surface complexation. It can be observed that the adsorption capacity increases as the iron content rises. An increase in Fe content signifies an increase in the density of active sites available for As(III) sorption via ligand-exchange. This can be due to the presence of interlayer and surface sorption of Fe(III). Therefore, the montmorillonite in the modified material behaves as a carrier material for Fe hydroxide, which is mainly responsible for arsenite adsorption.

The Langmuir, Freundlich, and D-R isotherm models were used to fit the adsorption data of MMT and modified MMT towards As(III). The Langmuir isotherm is based on monolayer adsorption on the active sites of the adsorption surface. The nonlinear form of the isotherm is expressed in the equation as follows:

$${q}_{e} = \frac{{X}_{m} {bC}_{e}}{1 + {bC}_{e}} \qquad ( 6 )$$

where qₑ and Cₑ are the amount of As(III) adsorbed per unit mass of adsorbent material (mg/g) and the equilibrium concentration of As(III) (mg/L), respectively. Xₘ and b are Langmuir constants, representing the monolayer capacity and equilibrium constant, respectively.

A very important characteristic of the Langmuir model is the dimensionless constant (R_{L}), generally known as the separation factor, is represented as:

$${R}_{L} = \frac{1}{1 + {bC}_{O}} \qquad ( 7 )$$

where C_{O} is the highest initial concentration (mg/L). The value of R_{L} indicates whether adsorption is irreversible (R_{L}=0), favorable (0<R_{L}<1), linear (R_{L}=1), or unfavorable (R_{L}>1). The Freundlich isotherm, on the other hand, depicts a non-ideal and reversible adsorption process not restricted to monolayer adsorption. The empirical model assumes a heterogeneous surface and that the amount adsorbed increases with solution concentration [56]. The non-linear form of the model is expressed as:

qₑ=K_{f}Cₑ^{1/n} (8)

where qₑ and Cₑ are the amount of As(III) adsorbed per unit mass of adsorbent material (mg/g) and the equilibrium concentration of As(III) (mg/L), respectively. K_{f} and n are Freundlich constants related to the adsorption capacity and intensity, respectively.

To obtain information about the predominant adsorption type, the Dubinin-Radushkevich (D-R) model was applied. The D-R isotherm is typically used to describe the sorption isotherms of single solute systems. The non-linear form of the model has been generally formulated as:

qₑ=(qₛ)exp(−βε²) (9)

where qₛ is the theoretical isotherm saturation capacity (mg/g), β is the Dubinin-Radushkevich isotherm constant (mol²/kJ²) related to the adsorption energy, and E is the Polyani potential. The Polyani potential (ε) can be deduced from the following formula:

$$ɛ = RT ln [ 1 + \frac{1}{{C}_{e}} ] \qquad ( 10 )$$

where R is the gas constant (8.314 J/mol-K), and T is the absolute temperature (K). The mean free energy of adsorption E (kJ/mol) can be computed by the following relationship:

$$E = [ \frac{1}{\sqrt{2 β}} ] \qquad ( 11 )$$

where E provides information on whether the adsorption mechanism is chemical or physical.

Adsorption isotherms of As(III) on MMT and 10% HyFe-MMT were conducted at various initial As(III) concentrations ranging from 0.25 to 10 mg/L and at 25° C. This concentration range is appropriate for wastewater treatment, wherein the acceptable concentration limits mostly lie within the considered range, while high enough for drinking water treatment. The experiments were conducted at an equilibrium time of 2 h and a pH of 6 since most of the arsenic affected drinking water pH ranges between 5.5 and 6.5.

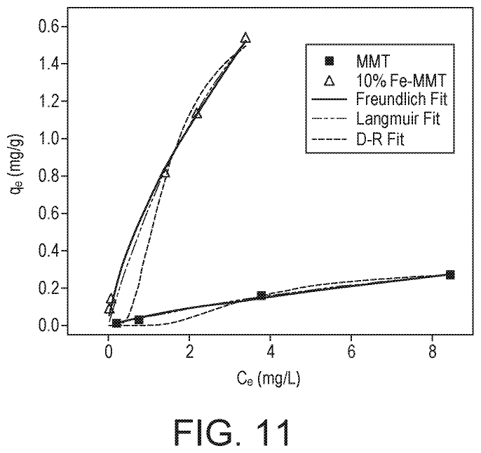

FIG. 11 shows the fitting of nonlinear Langmuir, Freundlich, and D-R isotherms to the adsorption data of As (III) onto MMT and 10% HyFe-MMT. Chi-square analysis was conducted to determine the degree of difference (χ²) between the experimental data and data calculated by the model and is determined by the following equation:

$$χ2 = \sum \frac{{( {q}_{e}^{exp} - {q}_{e}^{cal} )}^{2}}{{q}_{e}^{cal}} \qquad ( 12 )$$

where qₑ^{exp} (mg/g) is the experimental equilibrium adsorption capacity and qₑ^{cat} (mg/g) is the calculated equilibrium adsorption capacity. A smaller value for χ² indicates a better fitting isotherm.

In order to further validate the fitness of the isotherms to the adsorption experimental data, normalized standard deviation calculations (NSD (%)) were performed using the following formula:

$$N S D ( \% ) = 100 \times \sqrt{\frac{\sum {[ ( {q}_{e}^{exp} - {q}_{e}^{cal} ) / {q}_{e}^{exp} ]}^{2}}{N - 1}} \qquad ( 13 )$$

where N is the number of experimental measurements. Likewise, a smaller NSD (%) value would indicate a better fitting isotherm.

The results of χ² and NSD (%) in addition to the obtained isotherm parameters from nonlinear fitting are summarized in Table 4. From R² value, the Langmuir isotherm gave the best fit for MMT adsorption data while the Freundlich isotherm provided a best fit for 10% HyFe-MMT. The χ² and NSD (%) values further confirmed this indication. The adsorption of As(III) is a monolayer process on MMT and follows multilayer adsorption on HyFe-MMT.

TABLE 4
Isotherm model parameters for the adsorption of As(III) on MMT and 10% HyFe-MMT

| Langmuir isotherm | | | Freundlich isotherm | | | D-R isotherm | | |
|---|---|---|---|---|---|---|---|---|
| | | 10% | | | 10% | | | 10% |
| | | HyFe- | | | HyFe- | | | HyFe- |
| | MMT | MMT | | MMT | MMT | | MMT | MMT |
| Xₘ (mg/g) | 0.697 | 3.854 | K_{F} | 0.0312 | 0.696 | qₛ (mg/g) | 0.316 | 1.813 |
| | | | (mg/g/ | | | | | |
| | | | (dm³/g)ⁿ) | | | | | |
| R_{L} | 0.583 | 0.352 | 1/n | 0.783 | 0.679 | E (kJ/mol) | 0.494 | 1.029 |
| R² | 0.999 | 0.993 | R² | 0.993 | 0.999 | R² | 0.976 | 0.979 |
| X² | 2.89E−5 | 3.55E−3 | X² | 1.47E−4 | 5.00E−4 | X² | 5.29E−4 | 1.12E−2 |
| NSD (%) | 13.61 | 69.67 | NSD (%) | 38.44 | 52.70 | NSD (%) | 81.65 | 88.56 |

Furthermore, the Freundlich isotherm parameter (1/n), which measures the adsorption intensity of As(III) in the optimized solution, exhibited a value lower than unity. This behavior shows that significant adsorption can be expected even at higher As(III) ion concentrations. The value of (1/n) deviating from unity signifies the occurrence of nonlinear adsorption taking place on the heterogeneous surfaces. This occurrence indicates that the adsorption energy barrier increases exponentially as the elements of filled sites on the adsorbent increases.

The Langmuir separation factor R_{L} values were between 0 and 1 for both adsorbents, indicating that adsorption was favorable. A lower R_{L} value reflects that adsorption is more favorable. The value of R_{L} was found to decrease from 0.583 to 0.352 after modification of MMT, verifying that the affinity of the modified MMT towards As(III) increased.

The D-R model was applied to determine the apparent free energy of adsorption E which would provide an insight on the adsorption mechanism of the system. If the value of E <8 kJ/mol, then the process is dominated by physisorption and if it lies in the range of 8-20 kJ/mol, the adsorption is dominated by a chemical ion exchange process. The obtained energy values for MMT and HyFe-MMT were 0.494 kJ/mol and 1.029 kJ/mol, respectively, and are characteristic of physical adsorption.

According to the arsenic adsorption experiments, and existing reports about As(III) adsorption on hydroxymetal surfaces, it is evident that arsenite adsorption occurs by forming mixtures of both outer-sphere (physisorption) and inner sphere complexes (chemisorption) at the hydroxyiron nanoclay surface. The fast adsorption kinetics indicates an initial physisorption mechanism. Outer-sphere complexes retain their hydrated structure and no strong chemical bonds occur. Furthermore, as discussed previously, a slight drop in pH after adsorption indicates physisorption outer-sphere complexation where the arsenite is weakly bonded to the hydroxymetal surface via weak hydrogen bonds, which is confirmed by the D-R model. However, pH experiments show that at high hydroxyiron concentrations, the adsorption is independent of pH in the range of 4-9. Adsorption behavior that is unaffected by pH provides evidence for inner-sphere complexation in which the As(III) species could presumably exchange with surface —OH groups that are directly coordinated to the Fe(III) surface It is to be understood that the present subject matter is not limited to the embodiments described above, but encompasses any and all embodiments within the scope of the following claims.

We claim:

1. A method for adsorption of toxic contaminants from water, comprising the steps of:
providing a modified montmorillonite, the modified montmorillonite including a plurality of montmorillonite layers and a metal hydroxide modifier, the metal hydroxide modifier being intercalated between the montmorillonite layers and on a surface of an outer montmorillonite layer, the modified montmorillonite including at least about 80 wt % montmorillonite and about 1 wt % to about 20 wt % metal hydroxide modifier, the metal hydroxide modifier including at least one of iron, manganese, aluminum, cobalt and copper;
contacting the modified montmorillonite with the water; and
adsorbing the toxic contaminants from the water with the modified montmorillonite.

2. The method for adsorption of toxic contaminants from water according to claim 1, wherein the toxic contaminants comprise at least one of arsenic, barium, strontium, and phosphate.

3. The method for adsorption of toxic contaminants from water according to claim 2, wherein the arsenic comprises at least one of arsenite (As (III)) and arsenate (As (V)).

4. The method for adsorption of toxic contaminants from water according to claim 1, wherein the step of providing a modified montmorillonite comprises:
preparing an aqueous montmorillonite clay solution;
adding a metal hydroxide solution to the aqueous montmorillonite clay solution to form a first reaction solution;
adding ammonium hydroxide to the first reaction solution to form a second reaction solution;
heating the second reaction solution under constant stirring to form a modified montmorillonite clay solution;
washing the modified montmorillonite clay solution; and
drying the washed montmorillonite clay solution to obtain the modified montmorillonite.

5. A method of synthesizing modified montmorillonite, comprising the steps of:
preparing an aqueous montmorillonite clay solution;
adding a metal hydroxide solution to the aqueous montmorillonite clay solution to form a first reaction solution;
adding ammonium hydroxide to the first reaction solution to form a second reaction solution;
heating the second reaction solution under constant stirring to form a modified montmorillonite clay solution;
washing the modified montmorillonite clay solution; and
drying the washed montmorillonite clay solution to obtain the modified montmorillonite.

6. The method of synthesizing modified montmorillonite according to claim 5, wherein the amount of metal hydroxide solution is proportionately 1-20 weight % of the montmorillonite clay solution.

7. The method of synthesizing modified montmorillonite according to claim 5, wherein the metal hydroxide solution is selected from the group consisting of iron hydroxide, manganese hydroxide, aluminum hydroxide, cobalt hydroxide and copper hydroxide.

8. The method of synthesizing modified montmorillonite according to claim 5, wherein the metal hydroxide solution is added dropwise to the aqueous montmorillonite clay solution.

9. The method of synthesizing modified montmorillonite according to claim 5, wherein the second reaction solution is heated to about 80° C. for about 2 hours to about 4 hours.

10. An adsorbent comprising the modified montmorillonite prepared according to the method of claim 5.

11. A method of synthesizing iron modified montmorillonite, comprising the steps of:
preparing an aqueous montmorillonite clay solution;
adding an iron (III) hexahydrate (FeCl₃.6H₂O) solution to the aqueous montmorillonite clay solution to form a first reaction solution;
adding a diluted ammonium hydroxide solution to the first reaction solution to form a second reaction solution;
heating the second reaction solution under constant stirring to form an iron modified montmorillonite clay solution; and
separating the iron modified montmorillonite from the modified montmorillonite clay solution to provide the iron modified montmorillonite.

12. The method of synthesizing iron modified montmorillonite according to claim 11, wherein the amount of iron (III) chloride hexahydrate solution is proportionately 1-20 weight % of the montmorillonite clay solution.

13. An adsorbent comprising iron modified montmorillonite prepared according to the method of claim 11.

14. The adsorbent according to claim 13, wherein an amount of iron loaded in the iron modified montmorillonite is about 1% to about 20% by weight of the modified montmorillonite.

15. The adsorbent according to claim 13, wherein the iron modified montmorillonite includes about 10% by weight iron, proportionate to the modified montmorillonite.

16. The adsorbent according to claim 13, further comprising a packed bed filter.
